(19) United States
(12) Patent Application Publication
(10) Pub. No.: US 2026/0134123 A1
(43) Pub. Date: May 14, 2026

(54) SYSTEM, METHOD AND APPARATUS FOR MANAGING CROSS-SECURITY DOMAIN DATA ACCESS

(71) Applicant: Beyond Aerospace Ltd., Kelowna (CA)

(72) Inventor: Oliver Michaelis, San Diego, CA (US)

(21) Appl. No.: 19/169,339

(22) Filed: Apr. 3, 2025

Related U.S. Application Data
(60) Provisional application No. 63/720,453, filed on Nov. 14, 2024.

(51) Int. Cl. G06F 21/62; G06F 21/60; H04L 9/00

(52) U.S. Cl. CPC G06F 21/6209; G06F 21/604; G06F 21/6245; H04L 9/50

(57) ABSTRACT

A system, method and apparatus are described for allowing cross-domain security access to data stored by a blockchain network. Data records are received and grouped based on common characteristics, and a transformative object model (TOM) is generated, containing two or more grouped data records. The TOM is provided to a blockchain network, where it is stored in a cryptographic block on a particular logical data channel of a plurality of logical data channels of the blockchain network. Each logical data channel is assigned a security level for storing data records having a security level equal to, or less, than the assigned security level of each logical data channel. Requests to access the data records are authorized by a smart contract of a particular logical data channel that received a request.

### I. CROSS-REFERENCE TO RELATED APPLICATIONS

The present application claims the benefit of U.S. provisional application Ser. No. 63/720,453 filed on Nov. 14, 2024.

### BACKGROUND

### II. Field of Use

The present invention relates to the field of blockchain technology and more specifically to a system, method and apparatus for controlling access to digital resources in a networked environment, whereby data may be exchanged between different security domains.

### III. Description of the Related Art

Blockchain technology has exploded into the mainstream recently, underlying the technology of cryptocurrencies. Blockchain technology utilizes encrypted, distributed, digital ledgers that record digital transactions that occur between two or more entities over the Internet. Multiple “nodes” in a blockchain network each keep a copy of a distributed ledger, and when a digital transaction occurs, each node, or a majority of nodes, in the network attempts to validate the transaction. When the transaction is validated by each of the validating nodes, it sends proof of the validation to the other nodes. Once a majority of the nodes agree that the proof is valid, the transaction is added to a plurality of other validated transactions, and a new “block” is written to the distributed ledger and updated on all of the nodes.

While blockchain technology is well-known, used as the technological backbone of digital cryptocurrencies, it may be used in other applications, such as voting, identification, data management and distribution, data storage, and many others.

When data belonging to different security domains is handled, the typical solution lies in segmentation of networks with discrete access controls that correspond to a domain boundary. The main problem with this approach is replication of network, computing and storage infrastructure across different network segments, and the use of specific, often statically-configured gateways between the network segments yielding a complex and inflexible topology. The use of such gateways is usually prescribed by the standards and security policies applicable to the respective security domains.

It would be desirable to avoid replication of network, computing and storage infrastructure when implementing a multi-domain network topology.

### SUMMARY

The embodiments herein describe systems, methods and apparatus for managing access to data across security domain boundaries utilizing decentralized, consensus-based execution of associated data redaction and aggregation functions on a blockchain network. In one embodiment, a system is described, for allowing cross-domain security access to data stored by a blockchain network, comprising an ingest gateway configured to receive data records from one or more data sources, each data record comprising an associated security level attribute indicating an associated security level of each data record, the ingest gateway further configured to generate transformable object models (TOMs), each of the TOMs comprising two or more data records having a common attribute irrespective of a security level of each data record, wherein each TOM is assigned a TOM security level attribute matching a highest security level attribute of the two or more data records used to create each TOM, wherein the blockchain network is coupled to the ingest gateway, the blockchain network comprising a plurality of processing nodes, the blockchain network providing a plurality of logical data channels, each of the logical data channels associated with a different security level, respectively, the plurality of processing nodes configured to each execute a smart contract for creating cryptographic blocks, each cryptographic block comprising a respective TOM, and to publish each cryptographic block on a respective logical data channel having a security level equal to the TOM security level of each TOM of each cryptographic block, respectively and a gateway, coupled to the blockchain network, for authenticating requests to access the data records stored in the cryptographic blocks of a first logical data channel assigned to the gateway.

In another embodiment, a method is described for allowing cross-domain security access to data stored by a blockchain network, the blockchain network providing a plurality of logical data channels, each of the logical data channels associated with a different security level, respectively, the method comprising, receiving data records over a wide-area network from one or more data sources, each data record comprising an associated security level attribute indicating an associated security level of each data record, generating transformable object models (TOMs), each of the TOMs comprising two or more data records having a common attribute irrespective of a security level of each data record, wherein each TOM is assigned a TOM security level attribute matching a highest security level attribute of the two or more data records used to create each TOM, sending the TOMs to the blockchain network, creating cryptographic blocks from the TOMs, each cryptographic block comprising a respective TOM, publishing each cryptographic block on a respective logical data channel having a security level equal to the TOM security level of each TOM of each cryptographic block, respectively and authorizing requests to access the data records stored in the cryptographic blocks stored on a first logical data channel.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a block diagram of one embodiment of a system for managing data across security domain boundaries;

FIG. 2 is a logical representation of three logical data channels and three associated logical authorization channels of a blockchain network as shown in FIG. 1.;

FIG. 3 is a simplified functional block diagram of any of the processing nodes, gateways, data sources, a data consumption device and a data record identification database as shown in FIG. 1; and

FIGS. 4A-4D represent a flow chart illustrating one embodiment of a method, performed by the system shown in FIG. 1, for managing access to data records across security domain boundaries.

### DETAILED DESCRIPTION

Embodiments of a system, method and apparatus are described for managing access to data across a plurality of security domain boundaries utilizing decentralized, consensus-based execution of data storage, redaction and aggregation functions on a blockchain network. The concepts described herein represent a technical solution to the technical problems described above with prior-art, multi-domain data management systems. The embodiments describe an improvement to data management technology, especially when data records having disparate levels of security classifications are being managed, by the use of, in some embodiments, transformative object models or “TOMs”. A TOM is a data object comprising a number of attributes that describe data and metadata associated with each TOM. Specifically, the technical improvements over the prior art allow administrators to reduce their costs of implementing and maintaining such data management systems because they allow administrators to avoid redundant network, computing and storage infrastructure. The embodiments also provide a flexible architecture that easily allows changes to access attributes associated with data records, as attributes can be dynamically redacted and aggregated as needed.

In general, the embodiments describe a blockchain network configured to support multiple, logical, cryptographically-separated data channels on common physical processing nodes of a blockchain. All or some of the processing nodes that form the blockchain network may be members of one or more of such channels, and access to channels is typically managed by dedicated gateways, in some embodiments, one gateway assigned to each logical data channel. Each logical data channel is typically assigned a particular security level, categorized from low to high, meaning more sensitive data with tighter access controls is stored on channels having higher security levels. Each gateway may allow direct access to data records stored on an associated logical data channel of the gateway as well as indirect access to data records stored on logical data channels having lower security levels. In one embodiment, each logical data channel may have its own set of gateways for data retrieval by requesting entities, whereby lower-privileged gateways typically do not have access to higher-privileged channels and, if desired, gateways can be completely constrained to a single individual channel. This enables precise control over which data is replicated onto which physical nodes, and which authorized gateways can provide programmatic access on to particular, specific channels.

In some embodiments, incoming data is organized into “containing objects” whereby each object contains one or more attributes. Each attribute may comprise associated metadata. For example, a containing object may comprise three attributes: a data attribute, a security level attribute and a distribution attribute. Metadata of the data attribute may comprise actual data or reference to actual data, such as a hyperlink, pointer, UUID, or some other information used to locate actual data. Metadata of the security level attribute may comprise a number (i.e., 1-10), a letter (i.e., A-D), a word (i.e., unclassified, classified, secret, top secret, etc.) or some other identifier indicating a security level of actual data. Metadata of the distribution attribute may comprise a list of entities authorized to access the actual data, such as a list of names, login credentials, ID codes, social security numbers, UUIDs, etc. or reference to an “authorization record” (as explained in U.S. Pat. No. 12,244,744). Other attributes may comprise an identifier assigned to each containing object, such as a cryptographic block ID. Further attributes may comprise information to validate the referenced actual data's integrity such as a hash value over a file. Yet further attributes may provide information suitable to data discovery and search, e.g. the geolocation of an origin of data.

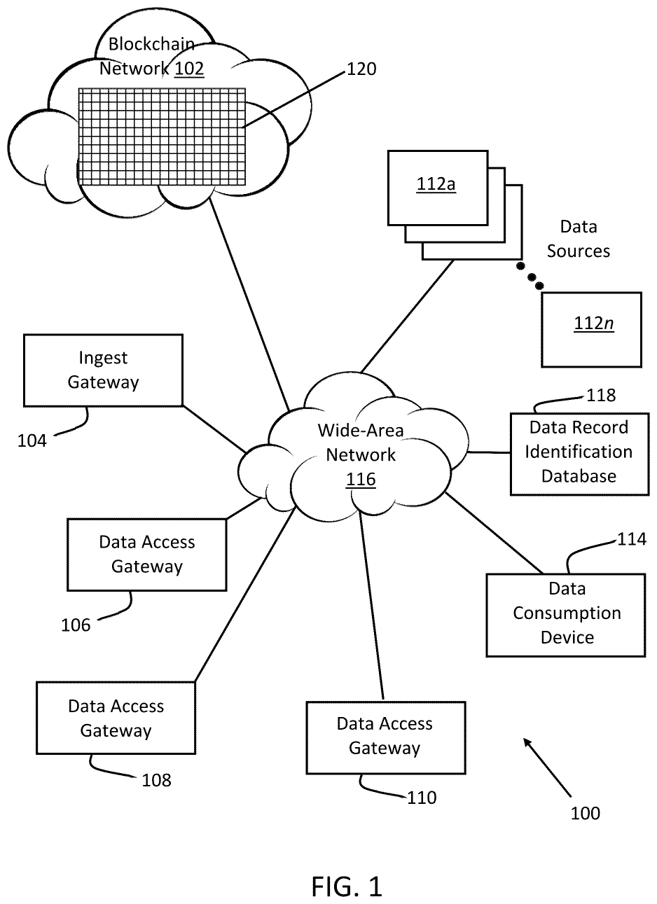

FIG. 1 is a block diagram of one embodiment of a system 100 for managing data across security domain boundaries. Shown is a blockchain network 102 (comprising a plurality of processing nodes 120), an ingest gateway 104, data access gateways 106, 108 and 110, data sources 112a-112n, a data consumption device 114, wide-area network 116 and a data record identification database 118.

Data sources 112a-112n comprise a plurality of electronic data generation devices, such as digital cameras, sensors, computers, mobile phones, or almost any electronic device capable of generating information and providing the information to ingest gateway 104 via wide-area network 116. Wide-area network 116 comprises one or more of a terrestrial cellular network, a satellite communication network, the Internet or some other geographically-disperse communication system. The data sources may be geographically displaced from one another in fixed or mobile environments (such as in vehicles, ships, aircraft, etc.). Each of the data sources may generate data records comprising information detected by each data source. Data records may be formatted into one or more different formats and transmitted via wire or wirelessly to wide-area network 116. In some embodiments, data is transmitted as “data records”, each data record comprising raw data captured by respective data source (such as an audio, video or audio-video recording, radar or other non-visible recordings, sensed data such as telemetry, temperature, pressure, documents, etc.), as well as associated metadata. The metadata may comprise a security level assigned by each data source (i.e., ranging from a low value, such as 1 and a high value, such as 10 out of a scale of between 1-10, for example), a location of each data source (such as GPS coordinates, an identification of an asset associate with a data source, such as an identification of a vehicle that a data source is located), a date and time that each data record was created, a mission identifier (i.e., an identification of a military mission (such as “Operation Bravo” or a civilian undertaking (such as “Undercover Stakeout #132”)) and/or a unique identifier of each data source (such as a serial number, a universally unique identifier (UUID), etc.). It should be understood that data records may be comprised of a single monolithic format such as a document file, or of packetized streams constituting many small data packets and associated time stamps or other unique packet identifiers.

Data records are received via wide-area network 116 by ingest gateway 104, comprising a computer server configured to process incoming data records. In one embodiment, ingest gateway 104 generates identification data for each data record received, such as a UUID, and provides the identification information, along with any metadata associated with each data record, to data record identification database 118, typically via wide-area network 116. The identification data may then be added to the metadata of each data record for identifying each data record later when requested by data consumers.

Ingest gateway 104 may also evaluate incoming data records, identify records having at least one common characteristic, associate similar data records with each other and form a combined output comprising the common data records and their associated metadata. In one embodiment, two or more data records, and their associated metadata, are combined into a transformative object model, herein referred to as a “TOM”. TOMs are each a specialized data structure comprising one or more “attributes” and metadata associated with each attribute. Typical attributes comprise a data attribute, a security level attribute and a distribution attribute, as explained earlier herein. Ingest gateway 104 constructs TOMs using two or more data records having at least one common characteristic, such as two or more data records from data sources participating in the same mission, two or more data sources in the same or similar location, two or more data records received within a predetermined time from one another (such as on the order of seconds, minutes hours or even days or weeks), two or more data sources associated with the same asset (such as two or more data sources on the same vehicle, person, aircraft, vessel, etc.), and/or some other common characteristic. For example, ingest gateway 104 may receive 100 data records within 60 seconds, the data records produced by 10 data sources, each data record comprising raw data and the metadata previously described. Ingest gateway 104 may determine that 3 of the 10 data records originated from data sources within a 100 foot diameter from each other and that 5 of the 10 data records originated from data sources involved in the same mission. In this case, ingest gateway 104 may generate two TOMs: a first TOM comprising the three data records and a second TOM comprising the five data records. An incoming data record may be validated by ingest gateway 104 based on cryptographic credentials configured in ingest gateway 104 to verify the source of the data record and the validity of the data itself. It should be understood that the ingest gateway 104's functions to validate data source and validity, and the construction of TOMs from one or more data records may itself be performed directly by ingest gateway 104, or in smart contracts on a logical data channel associated with ingest gateway 104.

In some embodiments, data records of disparate security levels may be combined into a single TOM. In this embodiment, ingest gateway 104 may determine a security level associated with each data record, based on the metadata of each data record, and assign an overall TOM security level to the TOM, the overall TOM security level equal to the highest security level of any data record in the TOM. In another embodiment, ingest gateway 104 may assign a security level higher than the highest security level of any data record in a TOM when ingest gateway 104 determines that, based on the totality of the data and metadata of the data records in a TOM, that the overall TOM security level should be assigned a higher security level than the highest security level of any of the data records in the TOM. For example, if one data record is received by ingest gateway 104 comprising a video from a digital video camera and another data record is received comprising high-resolution radar data of the same event, each data record may be classified as “medium” security. However, if these two data records are combined in a TOM, the TOM security level may be assigned a “high” security level, because the presence of both data records may provide further insight as to what is being observed not available when viewing either record on its own. In another example, multiple data streams sent from multiple drones are received, each data stream classified by each drone as a “medium” security level. However, if these data streams are grouped together in a single TOM, one could correctly assume that the drones are operating in a swarm configuration which may require a “high” security rating. The attributes of each data record may be evaluated and a correlation value assigned based on individual attributes of each data record. If the correlation value exceeds a predetermined threshold, the aggregation function may assign a TOM security level to the TOM higher than the highest security level of any of the applicable data records. When a data consumer accesses such TOMs, attributes may be dynamically redacted based on the consumer's domain association (i.e., security level) and access permissions. A TOM attribute may directly contain its respective value, or a resource identifier such as a URL to the respective data, e.g. a mass storage provider, a live streaming data feed, or e.g. an MQTT or a Kafka topic publishing information.

Once constructed, TOMs are sent by ingest gateway 104 to a plurality of processing nodes 120 of blockchain network 102. Each TOM is processed by at least some of the plurality of processing nodes 120 via chaincode executed by each processing node, the nodes configured to process TOMs from ingest gateway 104 in accordance with a smart contract of the chaincode and for at least one of the nodes to publish cryptographic blocks containing one or more TOMs onto particular logical data channels in accordance with an overall TOM security level of each TOM.

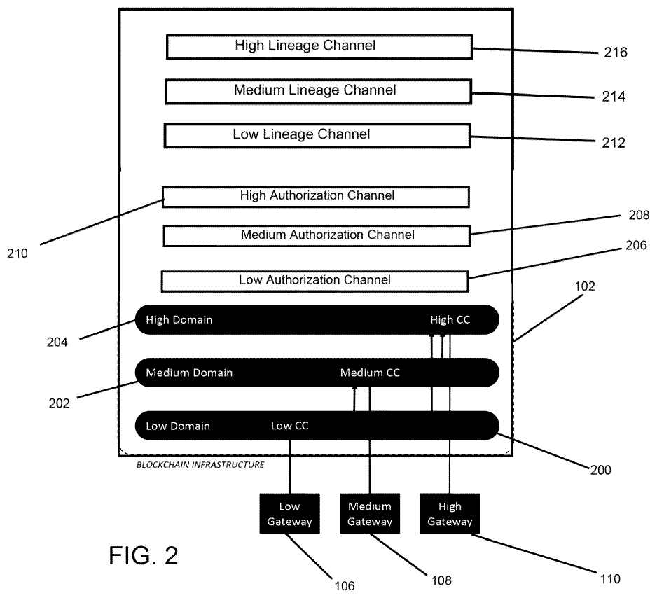

FIG. 2 is a logical representation of three, cryptographically-separated, logical data channels, three, optional, cryptographically-separated logical authorization channels each associated with one of the logical data channels, respectively, and three, optional, cryptographically-separated logical lineage channels each associated with one of the logical data channels, respectively, of blockchain network 102.

A first logical data channel 200 is pre-assigned with a first, “low” security level, a second logical data channel 202 is pre-assigned with a second, “medium” security level and a third logical data channel 204 is pre-assigned with a third, “high” security level. In this embodiment, authorization records are used to authorize access to TOMs stored on the logical data channels, as described in U.S. Pat. No. 12,244,744. In embodiments that utilize authorization records, a “low” authorization channel 206 is associated with channel 200, a “medium” authorization channel 208 is associated with channel 202 and a “high” authorization channel 210 is associated with channel 206. Authorization channels are used to store authorization records, which provide detailed information indicating who may access a particular data record or TOM on a respective logical data channel and, in some cases, the circumstances under which an entity may access the data record or TOM. In embodiments that utilize lineage channels, a “low” lineage channel 212 is associated with logical data channel 200, a “medium” lineage channel 214 is associated with logical data channel 202 and a “high” lineage channel 216 is associated with channel 206. Each lineage channel is used to store the identity of TOMs used to create redacted, or aggregated, TOMs, as described in greater detail later herein.

Each of the channels 200-204 in FIG. 2 constitutes a logical, cryptographically-separated data channel for publishing cryptographic blocks containing TOMs, while authorization channels 206-210 are other logical, cryptographically-separated channels for publishing cryptographic blocks containing authorization records. While logically separated, each channel is managed by a respective chaincode, each comprising one or more smart contracts, each smart contract executed by the same, or a subset of, processing nodes of blockchain network 102. In this way, physical redundancy of processing nodes is avoided, resulting in greater efficiency and lower cost. As used herein, “chaincode” comprises one or more smart contracts, each smart contract for performing a particular function associated with managing access to data across a plurality of security domain boundaries.

In one embodiment, access to each logical data channel 200-204 is managed by a respective gateway, in this example, logical data channel 200 is directly accessed only via data access gateway 106, logical data channel 202 is directly accessed only via data access gateway 108 and logical data channel 204 is accessed directly only via data access gateway 110. Each gateway comprises a networked computer server configured to receive requests for data records from requesting entities, such as end-user computers, authenticates requesting entities to ensure they are who they claim to be and have access privileges to a gateway's APIs that allow requesting entities access to blockchain network 102 (but not necessarily to data records stored on blockchain network 102). Access to data records, initiating a task, or triggering a function for a new transaction may each require authorization based on an authorization record published by chaincode on one of the authorization channels of blockchain network 102. Authorization to access data records, or to perform a task or other function, is performed by chaincode associated with a particular logical data channel to which the request was routed, wherein processing nodes 120, executing the chaincode, determine when the requesting entity's “credential attributes” (i.e., name, ID, security level, access list, location, time, date, etc.) match at least the minimum required conditions in a particular authorization record. Generally, authorization records stored on higher-security authorization channels cannot be accessed by chaincode associated with lower-security logical data channels.

In one embodiment, in response to receiving each data record request, each data access gateway queries data record identification database 118 to retrieve one or more identification codes associated with data records previously received by ingest gateway 104 and relevant to the request, and/or one or more identification codes of any TOMs created by ingest gateway 104 relevant to the request. For example, each data record received by ingest gateway 104 may be assigned a UUID by ingest gateway 104 or by data record identification database 118. When a request is received by data record identification database 118, it identifies any data records and/or TOMs matching search criteria contained in each request. For example, the request may comprise “All images from mission 123 between the hours of 14:00 and 15:00”. Data record identification database 118 then identifies any data records and/or TOMs comprising images associated with mission 123 between the hours of 14:00 and 15:00. The UUID's of any matching data records and/or toms are returned to the data access gateway that provided the request. The UUID(s), along with authorization credentials of the requesting entity, is then provided to a respective logical data channel for retrieval of one or more TOMs based on the UUIDs and the requestor's authorization credentials.

To retrieve data records stored on blockchain network 102, requesting entities send data requests to one of the gateways 106-110 via wide-area network 116. Each request comprises an identification of the requesting entity, at least one attribute of the requesting entity, and an identification of one or more data records for retrieval from blockchain network 102. An dentification of a requesting entity may comprise a name, login credentials, an authentication token, a UUID, an identification code, or some other identifier that uniquely identifies each requesting entity. Attributes of a requesting entity may comprise one or more of a security level,, a distribution membership credential, an assignment to a specific mission or task, a location of the requesting entity, an IP address of the requesting entity, an indication of whether a person requesting the data record(s) is currently gazing at a screen of a computer/tablet/mobile device, etc. The identification of data records may comprise an alpha-numeric code, a UUID, etc.

Once a requesting entity is validated by one of the gateways, a data request is sent to blockchain network 102 for processing via a smart contract associated with the particular logical data channel associated with the particular gateway handling the data request. In another embodiment where only one gateway is used to access more than one of the logical data channels, data requests are sent to blockchain network 102 for processing via a smart contract associated with a security level of the requesting entity.

In any case, processing nodes 120, via a smart contract associated with a particular logical data channel, process the data request by identifying a cryptographic block previously published on the particular logical data channel containing a TOM comprising the requested data record and then determining whether the requesting entity is authorized to access the data record.

Authorization may comprise a comparison of a requesting entity's security level by the processing nodes of blockchain 102 executing the smart contract with a TOM security level of the identified TOM and providing the identified TOM to the gateway that sent the data request if the security level of the requesting entity is equal to or great than the TOM security level. Since the TOM security level is typically equal or greater than the highest security level of any data record contained within the TOM, it is assumed that if the requesting entity has a security level equal to or exceeding the TOM security level, the requesting entity's security level will be equal to or higher than any of the data records contained within the TOM.

In another embodiment, authorization may comprise the processing nodes 120 executing the smart contract to retrieve information from an authorization record stored on one of the authorization channels 206-210. In this embodiment, each smart contract associated with each of the logical data channels 200-204 is configured to cause the processing nodes 120 to compare one or more attributes, or conditions, of an authorization record stored on a respective authorization channel to one or more attributes of the data request to determine whether to allow access to a data record stored on a respective logical data channel. For example, an authorization record stored in a cryptographic block on authorization channel 208 may list a minimum security level required to access a particular data record stored in a TOM on logical data channel 202. In another example, an authorization record on authorization channel 206 may comprise a distribution list identifying one or more persons or entities allowed to access a data record stored in a TOM on logical data channel 200. In yet another example, an authorization record stored on authorization channel 210 may require a minimum security level and a requirement that a requesting entity is gazing at a screen of a data consumption device 114, such as a computer, tablet or mobile device, in order to access a data record stored on logical data channel 204. In yet still another embodiment, an authorization record may require that a requesting entity be located in a particular location. Other conditions may be required, in addition or alternative to the aforementioned conditions, in order to access a data record. Generally, each authorization channel is associated with only one logical data channel such that authorization records stored on one authorization channel may only be used to authorize requests from a single, associated logical data channel.

When a requesting entity is authorized to access the requested data record by a comparison of one or more conditions of an authorization record, the processing nodes 120, via the smart contract, provides the TOM containing the requested data record to the requesting entity via the gateway that processed the data request.

When the security level of the requesting entity is less than the TOM security level containing the requested data, a new, redacted TOM may be created, containing only data records associated with a security level equal to or less than the security level of the requesting entity. In another embodiment, the redacted TOM comprise only the data record identified in the request. This may occur when a TOM comprises two or more data records, a first data record having an associated security level greater than the security level of the requesting entity and a second data record, matching the requested data record, having a security level equal to or lower than the security level of the requesting entity. In this embodiment, a second smart contract associated with the logical data channel processing the data request may create a redacted TOM using one or more data records of the TOM identified as comprising the requested data. The redacted TOM comprises the requested data and associated metadata and, in some embodiments, any other data records having a security level equal to or less than the security level of the requesting entity, and their associated metadata. The redacted TOM may be assigned a TOM security level by the second smart contract equal to the security level of the requested data (and the security level of the requesting entity). The resulting redacted TOM may be passed on to the requesting entity directly, or, one of the processing nodes, via the second smart contract, may then publish a cryptographic block containing the redacted TOM on a second, different logical data channel having a security level equal to the redacted TOM security level, and the newly published, redacted TOM is passed onto the requesting entity. Alternatively, an identification of the second data channel and the UUID of the redacted TOM may be passed to the requesting entity, for the requesting entity to then request the redacted TOM via its UUID from a gateway associated with the second channel. The cryptographic block containing the redacted TOM may persist on this second logical data channel indefinitely or, in other embodiments, for a predetermined amount of time before it is automatically deleted from the second logical data channel by the second smart contract. The redacted TOM may, additionally or alternatively to publishing a cryptographic block on the second logical data channel, be provided to the gateway that processed the data request for forwarding to the requesting entity.

In some embodiments, redaction occurs not only in response to requests for data records, but also in response to system events, where cryptographic blocks comprising redacted TOMs are automatically generated and published onto one or more different, lower-security logical data channels. This embodiment addresses use cases where a large number of entities may be interested in the same data records at the same security level, and avoids numerous, individual redactions based on single data record requests yielding effectively the same redacted TOM. Examples of system events comprise publishing a TOM with a certain set of distribution attributes, whereby each distribution attribute identifies a particular logical data channel and a particular TOM security level, publishing TOMs associated with a specific mission or data source identifier, etc.

In some embodiments, data records of different TOMs stored in different cryptographic blocks and/or on different logical data channels may be combined into a new, aggregated TOM. In this embodiment, when a request for multiple data records is received, and at least one of the requested data records is associated with a security level different than another requested data record, the requested data records are located and a new, aggregated TOM is formed using the requested data and metadata found in the TOMs containing the requested data records. The new, aggregated TOM may then be assigned a TOM security level equal to the highest security level of the requested data records of the new, aggregated TOM and the aggregated TOM stored on a logical data channel associated with the TOM security level. In some embodiments, each aggregated TOM may maintain references to the original data records and TOM identifiers from where the data records in the aggregated TOM originated, i.e., a UUID of a data record and its associated metadata, an indication of the TOM security level and/or logical data channel where the original data was located. Maintaining this data allows users of system 100 see the complete history, or “lineage” of how an aggregated TOM was constructed. In another embodiment the new aggregated TOM may be assigned a security level higher than the highest security level of any of its individual attributes based on the correlation value of the aggregated data records.

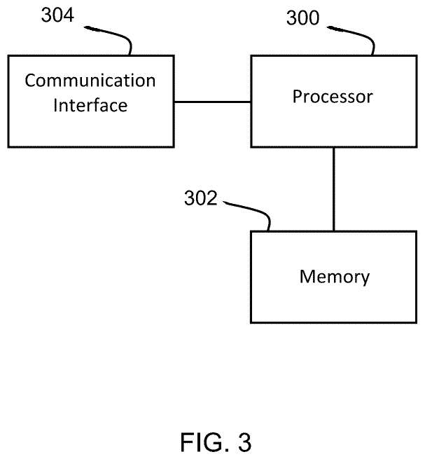

FIG. 3 is a simplified functional block diagram of any of the processing nodes 120, gateways 104-110, data sources 112, data consumption device 114 and data record identification database 118 as shown in FIG. 1, each comprising one or more hardware processors 300, one or more non-transitory memories 302, and one or more communication interfaces 304.

Processor 300 is configured to provide general operation of each node 120, gateway 104-110, data source 112, data consumption device 114 and data record identification database 118, by executing respective sets of processor-executable instructions stored in a respective memory 302, for example, executable computer code. Processor 300 typically comprises one or more general or specialized microprocessors, microcontrollers, and/or customized ASICs, selected based on computational speed, cost, power consumption, and other factors relevant to device. When respective processor-executable instructions are loaded into respective memories 302 of each device, processor 300 may become a specialized processor that performs an inventive method as described herein.

Non-transitory memory 302 is coupled to processor 300 and comprises one or more non-transitory information storage devices, such as static and/or dynamic RAM, ROM, flash memory, or some other type of electronic, optical, or mechanical memory device. Memory 302 may comprise a database. Memory 302 is used to store processor-executable instructions for operation of each device, respectively, as well as information relevant to each device. For example, the memory of each processing node 120 may store chaincode comprising a number of smart contracts used in association with a plurality of logical data channels to publish and retrieve cryptographic blocks to/from a prescribed logical data channel, as well as the cryptographic blocks themselves. Authorization templates and authorization records may also be stored. The memory of each of the gateways may store identification credentials of a plurality of requesting entities for authorization to blockchain 102. The memory of data record identification database 118 may store identification codes that identify each data record in system 100. It should be understood that in some embodiments, a portion of memory 302 may be embedded into processor 300 and, further, that memory 302 excludes propagating signals.

Communication interface 304 is coupled to processor 300, comprising circuitry for sending and receiving information to/from other devices in system 100 typically via a local-area network and wide-area network 116. Communication interface 304 may comprise wireless circuitry for wirelessly sending and receiving information or it may comprise a hardware port and related circuitry to send and receive data via wire, for example, via Ethernet, USB, Bluetooth, etc. All of the above circuitry is well-known in the art.

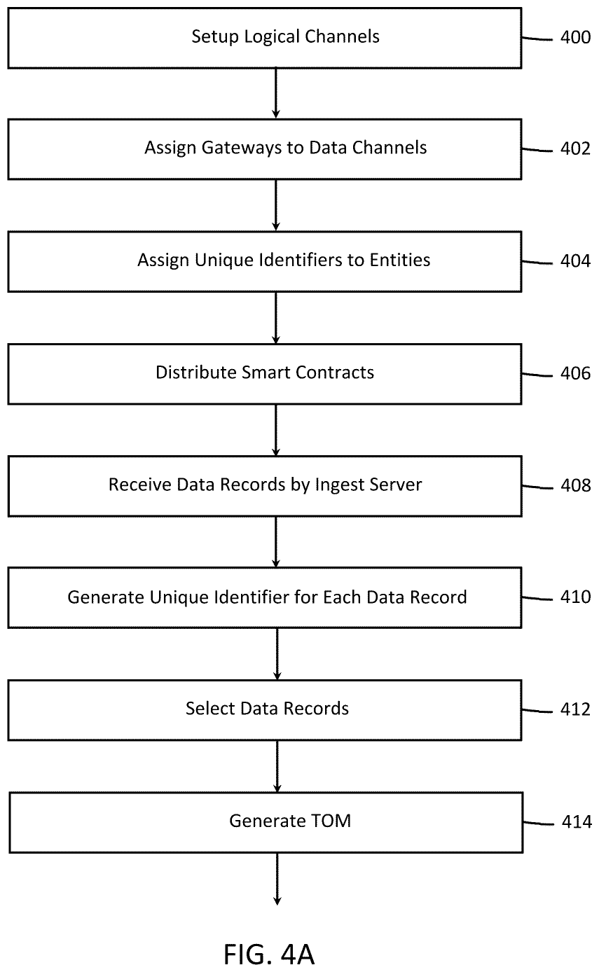

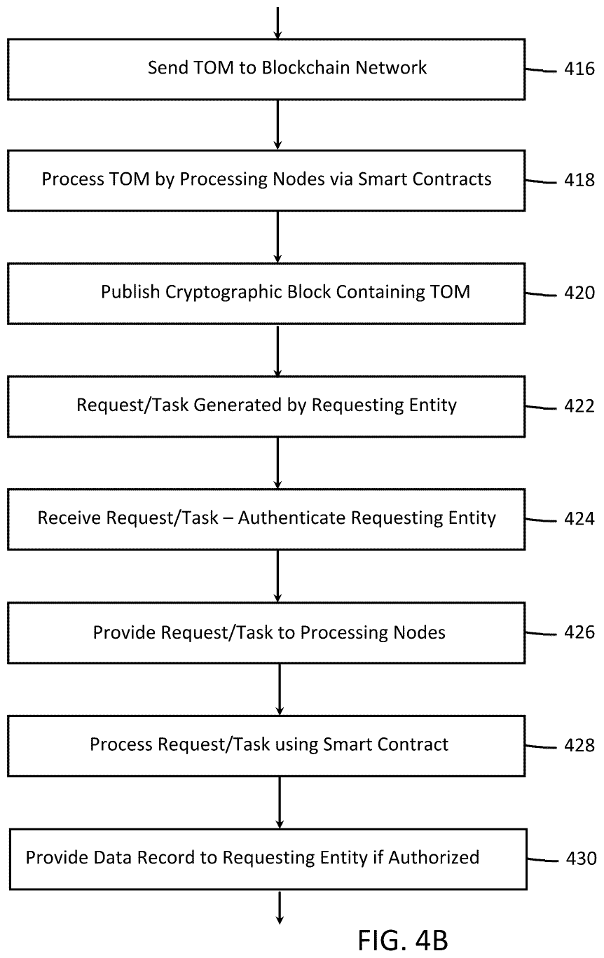

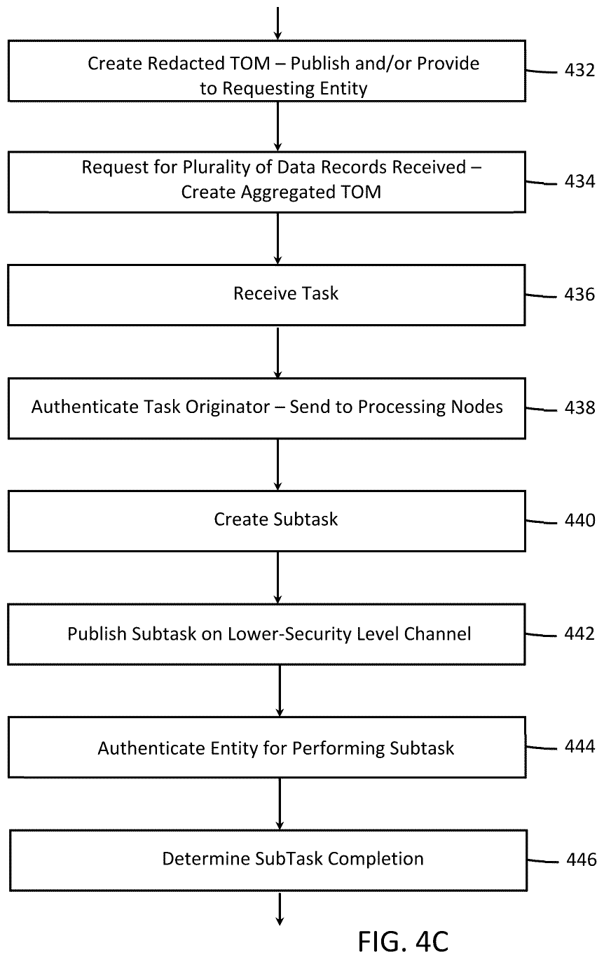

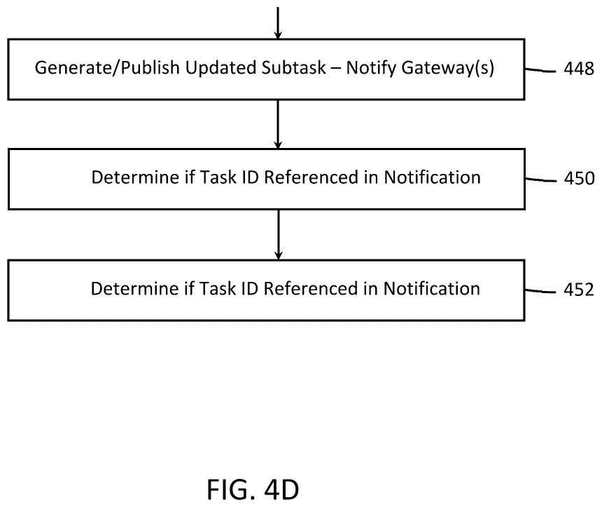

FIGS. 4A-4D represent a flow chart illustrating one embodiment of a method, performed by system 100 and the various entities thereof, for managing access to data records across security domain boundaries. More specifically, the method describes operations performed by a processor 300 in each processing node and device of system 100, each executing processor-executable instructions stored in a respective memory 302, even though processor 300, memory 302 and communication interface 304 may not be explicitly mentioned. It should be understood that in some embodiments, not all of the steps shown in FIGS. 4A-4D are performed, and that the order in which the steps are carried out may be different in other embodiments. It should be further understood that some minor method steps have been omitted for purposes of clarity.

At step 400, blockchain 102 is configured to support a plurality of logical data channels and, in some embodiments, one or more authorization channels. Each logical data channel is assigned a particular security level for publishing and storing cryptographic blocks containing one or more TOMs each having a TOM security level matching the security level of each logical data channel respectively. In embodiments using authorization channels, authorization channels may be assigned to each of the logical data channels, respectively.

At step 402, in one embodiment, each logical data channel is assigned a particular data access gateway, such as one of the data access gateways shown in FIG. 1. In one embodiment, each data access gateway is configured to access only one of the logical data channels.

At step 404, an issuing entity associated with at least some of the data records generated by data sources 112a-112n may assign unique identifiers to various devices, entities and assets in system 100. In one embodiment, each unique identifier comprises a universally unique ID (UUID).

At step 404, smart contracts are defined to implement the rules for TOM publication, retrieval, redaction, aggregation and authorization. Two or more smart contracts may be distributed to logical data channels and logical authorization channels as “chaincode”, each logical data channel and logical authorization channel receiving chaincode particular to a security level of each logical data channel and logical authorization channel.

At step 408, ingest gateway 104 receives the data records from data sources 112a-112n over time, and may generate a unique identifier for each data record received. In one embodiment, the unique identifier comprises a UUID. Each data record comprises raw data and associated metadata describing one or more attributes of the raw data. For example, the metadata may comprise a security level associated with the raw data in each data record, a date and time that the raw data was captured, a unique identifier of a device or person who captured the raw data, a distribution list identifying entities allowed to access the raw data, a mission identifier, a location where the raw data was captured, etc. These attributes may be assigned by each data source 112a-112n or, in other embodiments, some of the attributes may be assigned by ingest gateway 104. Ingest gateway 104 may send the unique identifier and an identification of each data record, the raw data itself and, in some embodiments, metadata associated with each data record, to data record identification database 118. In other embodiments, the unique identifier may be assigned by processing nodes 120 of blockchain 102 (or other processing nodes of a different blockchain) executing chaincode that generates and assigns the unique identifier. The same chaincode could also cause the processing nodes to authenticate the data record(s) of the TOM as well as assign the TOM security level to the TOM. In other embodiments, unique identifiers are generated by data record identification database 118 when it receives data records from ingest gateway 104.

Ingest server 104 may authenticate and integrity-check each data record received using well-known techniques, such as public-key cryptography, tokens, or the like. In other embodiments, the authentication and integrity-checking of each data record may be performed by processing nodes 120 of blockchain 102 (or other processing nodes of a different blockchain) executing chaincode that authenticates and integrity-checks the data records.

At step 410, ingest gateway 104 selects two or more data records for inclusion in generating a transformable object model (TOM) data structure. Selection is based on grouping data records having at least one common attribute. For example, it may be desirable to group two or more data records received within a one minute time period identified as associated with a particular mission. As another example, it may be desirable to group two or more data records identified as having been generated at a particular location, or within a predetermined radius of a predetermined location. Packetized, event-like data, e.g. telemetry measurements, may directly feed into a TOM, whereas stream-based sources may be correlated by their inherent timestamp, e.g. the PTS for an MPEG-TS stream, or a sequence number for a message stream, and bulk data such as files may be correlated by a file identifier on an external storage system. This provides a flexible way of associating data records having at least one common attribute independent of the data record's associated security level.

At step 412, after identifying two or more data records having at least one common attribute, a TOM is generated, comprising each included data record and its associated metadata (or a pointer to such data records, such as a URL, in an embodiment where ingest gateway 102 stores data records on an external storage system). In one embodiment, the TOM is assigned a TOM security level equal to the highest security level of any data record associated with the TOM. For example, if a TOM comprises three data records, one having a security level of “low”, another having a security level of “medium” and one having a security level of “high”, ingest gateway 104 may assign a TOM security level of “high” to the TOM. In another embodiment, the TOM security level may be higher than the highest security level of data records based on a “correlation value” of the individual data records, as explained earlier herein.

At step 414, the TOM is sent from ingest gateway 104 to blockchain network 102. In one embodiment, the TOM is sent to a particular logical data channel matching the TOM security level. In another embodiment, TOMs may be sent to a logical data channel of blockchain network 102 specifically designated to assign TOMs to one of the logical data channels of blockchain network 102.

At step 416, the TOM is received by the processing nodes 120 of blockchain network 102 and processed using a smart contract stored by each of the processing nodes. The smart contract may verify the TOM security level and the TOM is then processed by the processing nodes 120 to create a cryptographic block in accordance with well-known blockchain techniques, such as using cryptographic consensus techniques well known in the art, the cryptographic block comprising the TOM. The cryptographic block comprises a unique identifier to identify the block during data retrieval. The unique identifier may comprise the UUID assigned to the TOM. In another embodiment, as blocks are generated, they may be assigned a unique identifier, such as a 256-bit hash created by one or more of the processing nodes 120, and this unique identifier is stored in association with the UUID of any data records contained in each TOM.

In one embodiment, the smart contract may contain instructions to automatically generate a redacted TOM based on the metadata of at least some of the data records stored by the TOM. In this embodiment, when a TOM is received by a particular logical data channel, a smart contract associated with that channel causes the processing nodes 120 to determine the attributes of each data record, by the metadata of each data record, and determine if any of the data attributes match attributes pre-identified to trigger an automatic redaction of the TOM. For example, the smart contract may comprise instructions that causes an automatic redaction of any TOM that contains at least one data record recorded at a particular location. The smart contract may further comprise an identification of which one or more logical data channels to publish a redacted TOM, and instructions that causes the processing nodes to remove any data records having a security level greater than a security level of one or more logical data channels where the redacted TOM will be published. For example, if a TOM comprises four data records, two having a “high” security level, another having a “medium” security level and another having a “low” security level, the smart contract may comprise instructions to create a redacted TOM for publication on the medium-security logical data channel and further instructions to only include data records in the redacted TOM having a security level less than or equal to the medium security level. In a related embodiment, the smart contract may comprise instructions that causes two or more redacted TOMs to be created, one redacted TOM for each logical data channel having a respective security level equal to or lower than the TOM security level. Continuing from the example above, the processing nodes 120 would cause a first redacted TOM to be created comprising the medium security-level data record and the low security-level data record for publication on the medium-security logical data the channel and cause a second redacted TOM to be created for publication on the low-security logical data channel comprising only the low security-level data record.

In another embodiment that utilizes authorization records, upon receipt of a TOM by processing nodes 120 from ingest gateway 104, a smart contract associated with a logical data channel where the TOM will be published determines whether to automatically generate a redacted TOM based on an authorization record stored in a cryptographic block of an associated authorization channel. For example, an authorization record may have previously been published on authorization channel 208 indicating criteria for automatically creating redacted TOMs for publication on a lower-security logical data channel, such as logical data channel 200. The authorization record may indicate that any TOM having data records of disparate security levels should be redacted when the metadata associated with any of the data records indicate that they are associated with a particular distribution, a particular mission, were generated from a particular location, during certain, particular time periods, etc. When a TOM is received by processing nodes 120 comprising data records whose metadata meets the conditions of such an authorization record, the smart contract of the logical data channel, in this example logical data channel 202, causes the processing nodes 120, via the smart contract associated with logical data channel 202, to automatically generate a redacted TOM, and the authorization record may indicate how the redacted TOM is to be constructed, i.e., which data to include or exclude from the redacted TOM, on which particular logical data channels to publish the redacted TOM, which overall security level to assign to the TOM, etc. After creating the redacted TOM, it may be provided by the smart contract associated with logical data channel 202 and either provided to a smart contract associated with logical data channel 200 for publication on logical data channel 200 or the redacted TOM may be published on logical data channel 200 by the smart contract associated with logical data channel 202, since access to logical data channel 200, being a lower-security channel than logical data channel 202, may be permitted in some embodiments.

In one embodiment, one or more “lineage properties” associated with the redaction may be memorialized on one or more dedicated lineage channels 212-216. Using the example above, when a redacted TOM is created from a data record stored on logical data channel 202 and the redacted TOM is stored on logical data channel 200, a first lineage record may be generated by processing nodes 120 executing a smart contract, the first lineage record comprising UUIDs of the data records used to create the redacted TOM, an identification of an authorization record on authorization channel 208 that caused the redacted TOM to be created and/or an identification of the redacted TOM. The identifications typically comprise a unique identifiers, such as UUIDs. Other attributes may also be included, such as the date and time that the redacted TOM was created. A second lineage record may be generated by processing nodes 120 executing the smart contract, the second lineage record comprising an identification of the TOM used to create the redacted TOM and an identification of the authorization record on authorization channel 208 that caused the redacted TOM to be created. The identifications typically comprise a unique identifiers, such as UUIDs. Other attributes may also be included, such as the date and time that the redacted TOM was created. The second lineage record may mask the identification of the TOM used to create the redacted TOM in embodiments where it is desirable to limit this information to entities accessing lineage channel 212 via data access gateway 106 and logical data channel 200. Maintaining the lineage records on separate channels provides exact control over access to these records versus providing direct access to the data identified by the lineage records.

At step 418, the cryptographic block comprising the TOM is published on a particular logical data channel in accordance with the TOM security level of the TOM. Any one or more other cryptographic blocks comprising one or more redacted TOMs are published on a respective logical data channel, as described above.

At step 420, a requesting entity, such as a person associated with a mission, may use a data consumption device 114 to request one or more data records from blockchain network 102. Each data record request may comprise an identification of the one or more data records requested and metadata in the form of one or more of an identification of the requesting entity (i.e., name, ID code, UUID, social security number, etc.), login credentials, an authentication token, a security level of the requesting entity, a location of the requesting entity, a permission to access certain data records, an indication of whether the user is gazing at the screen of data consumption device 114, etc. Alternatively, a “task” may be generated by a requesting entity, the task comprising subtasks that may involve a plurality of entities in system 100 having disparate security levels. It should be noted that the requested entity may be a person, a compute node acting on behalf of a person, or a compute node acting based on algorithmic or autonomous behavioral definitions configured in the compute node.

At step 422, the data record request or task is received by one of the data access gateways as shown in FIG. 1 and processed. Processing may comprise authentication of the requesting entity to determine the data record request or task actually originated from the entity who purportedly sent the data record request or task. For example, a data record request or task may be received by data access gateway 106 which has direct access to medium-security logical data channel 202 of blockchain 102. Gateway 106 may then authenticate the requesting entity using one of a variety of well-known methods, such as comparing login credentials to known credentials, verifying the validity of an authentication token, public key cryptography, etc.

In one embodiment, the request comprises one or more metadata constraints to used to identify TOMs or data records of interest, by, e.g. by specifying a time frame, a geographic area, a particular data source or source type, etc. These metadata constraints may be passed onto data record identification database 118 to identify all relevant data records and/or TOMs that fulfil these metadata constraints. The resulting list of data record and/or TOM UUIDs that match the metadata constraints is then provided by data record identification database to ingest gateway 104 where it may be added to the metadata of the request.

At step 424, once the requesting entity has been authenticated, the request or task, including at least some of the metadata, is provided to each of the processing nodes 120 of blockchain network 102.

At step 426, the request or task and associated metadata is processed by each of the processing nodes 120. In one embodiment, a smart contract associated with logical data channel 202 is executed by the processing nodes 120, the smart contract configured to cause the processing nodes 122 to evaluate the request or task in order to determine if the requesting entity is authorized to access the identified data record(s), to perform the task and/or to access data records associated with the task.

For data record(s) requests, the processing nodes 120 each identify one or more TOMs stored on logical data channel 202 containing the requested data record(s). In one embodiment, the request comprises an identification of the requested data in the form of TOM UUIDs and the processing nodes 120 each compare the identification of the requested data to the identification of stored data records in each TOM of logical data channel 202 to identify the applicable TOM(s).

In one embodiment, authorization is determined by the processing nodes 120 obtaining an authorization record from an authorization channel associated with logical data channel 202, in this case, authorization channel 208. In this embodiment, the authorization record comprises a listing of conditions needed to access a particular data record, such as a minimum security level, a valid time period, a listing of identifications of entities authorized to access the data record, a required location of the requested entity, whether the entity is gazing at a display screen of a data consumption device 114, etc. Each authorization record may be generated using an authorization event template stored on authorization channel 208, as explained in U.S. Pat. No. 12,244,744. Specifically, an issuing entity (such as a military command center, a central authority), or one of its delegates, may generate an authorization event template with schema, or fields, for another entity to enter particular criteria for accessing a particular data record, such as an entity's accessible domains, distributions, and any other optional contextual attributes such as a constraint to a geographic area or a time-bound authorization. The authorization event template may then be posted it one or more of the authorization channels 206-210. Authorization templates may then be accessed by certain entities in system 100 for creating authorization records by providing particular criteria to a smart contract associated with one of the logical data channels. Processing nodes 120 use the smart contract to create authorization records based on a particular authorization event template and the criteria provided by an entity creating the authorization record. Once created, authorization records are stored on a respective authorization channel.

To retrieve a data record having an associated authorization record, each entity in system 100 may be issued credentials for presentation to processing nodes 120, using a smart contract associated with a particular logical data channel, and the processing nodes 120 authorize access to the data record based on the metadata of a data record request to the conditions in the authorization record to determine whether the requesting entity is permitted to access the data record(s) identified in the request.

At step 428, when the security level of the requesting entity is equal to or greater than the security level of the requested data record(s), one or more identified TOMs containing the requested data record(s) is/are extracted from a respective cryptographic block(s) stored on logical data channel 202, and the identified TOM(s) are provided to the gateway that sent the data record request, in this case, 106. Gateway 106 then forwards the identified TOM(s) to the requesting entity via wide-area network 116.

At step 430, when the security level of the requesting entity is less than the security level of any of the TOMs'security level containing the requested data record(s), a new, redacted TOM may be created for such each original TOM, containing only data records and respective metadata of the TOM associated with a security level equal to or less than the security level of the requesting entity. In another embodiment, only the requested data records are retrieved from the identified TOM and used to form a redacted TOM. Redaction of data records and associated metadata may occur when a TOM comprises two or more data records, a first data record having an associated security level greater than the security level of the requesting entity and a second data record equal to or less than the requesting entity.

In this embodiment, processing nodes 120, via the smart contract associated with the logical data channel processing the data request, causes the processing nodes 120 to identify data records in a TOM previously published in a cryptographic block on the particular logical data channel having a TOM security level greater than the security level of the requesting entity, that comprise a security level equal to or lower than the security level of the requesting entity. Then, the identified data record(s), as well as its/their corresponding metadata, is/are formed into a new, redacted TOM by processing nodes 120 using the smart contract. A new, TOM security level is assigned to the redacted TOM equal to the highest security level of the data records contained therein.

Next, one of the processing nodes 120, may publish a cryptographic block containing the redacted TOM on a different logical data channel having a security level equal to, and/or less than, the redacted TOM security level. The cryptographic block containing the redacted TOM may persist on this second logical data channel indefinitely or, in other embodiments, for a predetermined amount of time before it is automatically deleted from the second logical data channel by the smart contract. The redacted TOM may, additionally or alternatively to publishing a cryptographic block on the second logical data channel, be provided to the gateway that processed the data request for forwarding to the requesting entity. Alternatively, the redacted TOM's UUID and the identifier of the second logical data channel may be provided to the gateway that processed the data request for forwarding to the requesting entity, for the requesting entity to request the redacted TOM in a separate operation via a gateway associated with the second logical data channel.

At step 432, a request for two or more data records is received by one of the data access gateways shown in FIG. 1. The request is processed as previously described, by first authenticating the identity of the requesting entity and then providing the request to blockchain network 102 for processing via a smart contract associated with the security level associated with the particular data access gateway that processed the request. In this embodiment, the request was provided by data access gateway 108 (medium security level), the request comprising an identification of the requesting entity, including associated metadata, as well as an identification of the data records requested.

The processing nodes 120 receive the request and verify that the requesting entity is authorized to access the requested data records, as explained above. If authorized, the processing nodes 120 identify where each of the first and second data records are located, as explained earlier herein, i.e., an identification of a first cryptographic block containing a first TOM on, for example, logical data channel 202 and an identification of a second cryptographic block containing a second TOM on logical data channel 200 (low security level). The smart contract further instructs the processing nodes 122 to retrieve the first and second data records from each of the TOMs, respectively, and create a new, aggregated TOM comprising the first data record and the second data record and their associated metadata.

The new, aggregated TOM may then be assigned a TOM security level equal to the highest security level of the first and second data records. The aggregated TOM is then published in a cryptographic block by one of the processing nodes 120 on a logical data channel associated with the TOM security level of the aggregated TOM. In some embodiments, the smart contract additionally instructs the processing nodes 120 to create one or more lineage records, as explained earlier herein, to store references to the first and second data records and TOM identifiers from where the first and second data records in the aggregated TOM originated, i.e., a UUID of each data record and its associated metadata, an indication of the TOM security level where each data record was stored and/or an identification of a particular logical data channel where each TOM was located. Maintaining this data allows users of system 100 to see the complete history, or “lineage,” of how an aggregated TOM was constructed. The lineage records created from the aggregation of TOMs may be stored on separate lineage channels in association with the logical data channels involved in obtaining date records for aggregation and publication of one or more aggregated TOMS, similar to how lineage records are stored with respect to redacted TOMS, as explained earlier herein.

At step 434, when a task is received by one of the data access gateways as shown in FIG. 1, the gateway authenticates the task requestor to determine if the task requestor is who he/she/they it purports to be, as described earlier herein. The task may comprise a series of subtasks, where each subtask may identify an entity or person assigned to complete each sub task and, in some embodiments, a security level associated with each entity or person assigned to complete the various subtasks, and, in further embodiments, one or more distribution identifiers each entity or person is associated with. The task typically additionally comprises metadata associated with the task, such as the task requestor's security level, location, identification, etc. A task may further comprise an identification of data records for completing each subtask and redaction rules to create either redacted, or aggregated, TOMs.

At step 436, when the task requestor has been authenticated, the task and associated metadata is forwarded to blockchain network 102, to processing nodes 120.

At step 438, the task is processed by the processing nodes 120 via a smart contract stored by each of the processing node 120. Processing comprises initiating the task upon detection of a predetermined event (such as receiving a command from the task requestor to execute the task, detecting that a prescribed date and time has been reached, receiving a notification from an entity of system 100 that a particular, predefined action has commenced, etc.), and then assigning the subtasks to the identified entities or persons. In another embodiment, the task may reference an authorization record stored on one of the authorization channels 206-210 that contain a listing of particular information necessary to perform the task, such as an identification of particular subtasks, an identification of entities required to perform each subtask, a security level associated with each subtask, an identification of data records needed to perform each subtask, authorization criteria to access each of the data records, etc. The processing nodes 120, via the smart contract associated with a particular logical data channel processing the task request, then applies the criteria listed in the authorization record track the progress of the task as each subtask is completed by each of the identified entities in the authorization record.

For example, a task may be predefined by an entity of system 100 having a medium security level using an authorized event template previously generated by an issuing entity of system 100. The entity provides an identification of a number of subtasks and, in some embodiments, an identification of an entity to perform each subtask, and authorization criteria required by each entity to access a particular subtask and access data records associated with the subtask. A task authorization record is then generated and published on an authorization channel containing the task and an identification code of the task, such as a UUID. The UUID may be provided to the entity that requested creation of the task.

The task may be initiated by the entity that created the task or another entity identified in the task authorization record by submitting a task initiation request identifying the requesting entity and an identification of the task via one of the data access gateways, in this example, data access gateway 108. In this example, the requesting entity has a “medium” security level. After the requesting entity has been authenticated by gateway 108, the request is sent to processing nodes 120, where a smart contract associated with logical data channel 202 is executed by processing nodes 120 to determine whether the requesting entity is authorized to initiate the task. This is accomplished by accessing authorization channel 208, identifying a task authorization record using the task identification number in the request, and determining if the requesting entity has a security level, or other attributes required by the task authorization record, equal to or greater than the minimum security level to initiate the task, as identified in the task. If so, the processing nodes 120, via the smart contract, retrieves the information in the task authorization record from authorization channel 208.

At step 440, upon initiation of the task, in this example, the processing nodes 120, via the smart contract, may create a subtask record comprising a first subtask listed in the task when the subtask requires performance by an entity in system 100 having a security level less than the security level of logical data channel 202, i.e., in this example, a “low” security level. The subtask may be assigned a unique identifier and the identifier associated with the task, such as a UUID for both. In one embodiment, the smart contract associated with logical data channel 202 additionally may create a redacted TOM, or an aggregated TOM, by locating one or more cryptographic blocks stored on any of the logical data channels of blockchain network 102 that contains a TOM having the required data record(s) to complete the subtask by the entity having the lower security level. In this embodiment, the redacted, or aggregated, TOM is formed using only data records having the low security clearance, however, in other embodiments, reaction or aggregation may be based on redaction and or aggregation rules as specified by the task. Once formed, the redacted or aggregated TOM is published to logical data channel 200 via the smart contract of logical data channel 202 where it may be accessed by the entity for performing the subtask.

At step 442, continuing with the example above, the subtask is published on the lower channel in a cryptographic block, i.e. logical data channel 200, and an entity identified for performing the subtask may be notified that the subtask is ready for performance.

At step 444, the entity required to perform the subtask may request access to the subtask and any data records associated with the subtask by sending the request to data access gateway 106. The request is received by gateway 106 and the entity is typically authenticated using metadata associated with the request, similar to how data record requests comprise various metadata. Once authenticated, the request is sent to blockchain network 102 and processed by the processing nodes 120 via a smart contract associated with logical data channel 200. In response, the smart contract may perform authorization to determine if the entity is authorized to access the subtask and related data records, as explained above. If so, the smart contract then provides the subtask and any related TOMs published on logical data channel 200 to the entity via gateway 106.

At step 446, the smart contract associated with logical data channel 200 determines when the subtask has been completed, typically by receiving a subtask response from the entity that performed the subtask and then validating the response by processing nodes 120 using cryptographic consensus techniques well-known in the art. The subtask response may comprise virtually any type of data generated by the entity in performing the subtask.

At step 448, in response to determining that the subtask has been completed, the smart contract associated with logical data channel 200 may generate an updated subtask indicating that the original subtask previously published on logical data channel 200 has been completed. The updated subtask comprises a unique identifier, the unique identifier of the original subtask and the unique identifier of the task. The updated subtask is then published on logical data channel 200. The smart contract may additionally send a notification to one or more of the data access gateways of system 100, notifying the gateway(s) that a change has occurred with respect to the subtask, and identification of the updated subtask and the identification of the task published on logical data channel 202. The change may comprise authorizing an entity to access the subtask (i.e., from step 442) or completion of the subtask (i.e., from step 444).

At step 450, gateway 108 receives the notification from the smart contract associated with logical data channel 200 and, in response, determines whether the task identified in the notification by the unique task identifier has been previously published on logical data channel 202.

At step 452, when gateway 108 determines that the task identified by the task identifier has previously been published on logical data channel 202, gateway 108 causes processing nodes 120, via the smart contract associated with logical data channel 202, to retrieve the updated subtask from logical data channel 200, to create an updated task and publish the updated task on logical data channel 202. The updated task comprises a copy of the original task previously published on logical data channel 202, except that the updated task lists the first subtask as having been completed and a copy of the updated subtask identifying which entity performed the subtask, a date and time of performance, a location of the entity, any data generated by the performing entity, etc.

Although specific advantages have been enumerated above, various embodiments may include some, none, or all of the enumerated advantages. Other technical advantages may become readily apparent to one of ordinary skill in the art after review of the foregoing figures and description.

It should be understood at the outset that, although exemplary embodiments are illustrated in the figures and described above, the principles of the present disclosure may be implemented using any number of techniques, whether currently known or not. The present disclosure should in no way be limited to the exemplary implementations and techniques illustrated in the drawings and described above.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. The article “a” means “one or more”.

In many places in this document, actions (e.g., functionality) are performed by one or more processors executing processor-executable instructions (i.e., software, firmware). This is done for ease of description; it should be understood that, whenever it is described in this document that software performs any action, the action is in actuality performed by underlying hardware elements (such as a processor and a memory device) according to the instructions that comprise the software. Such functionality may, in some embodiments, be provided in the form of firmware and/or hardware implementations.

As used herein, the term LLM or large language model, includes other types of models. Accordingly, whenever it is mentioned herein that an LLM may be used, other types of models may also be used. The models may be neural networks or other types of machine-learned models that provide an output (e.g., a predictive output) from a given input. When prompted, inference may be performed on the indicated model (e.g., the LLM) that then provides a response.

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

Whenever it is stated herein that a hardware element (e.g., a processor, a network interface, a display interface, a user input adapter, a memory device, or other hardware element), or combination of hardware elements, is “configured to” perform some action, it should be understood that such language specifies a physical state of configuration of the hardware element(s) and not mere intended use or capability of the hardware element(s). The physical state of configuration of the hardware elements(s) fundamentally ties the action(s) recited following the “configured to” phrase to the physical characteristics of the hardware element(s) recited before the “configured to” phrase. In some embodiments, the physical state of configuration of the hardware elements may be realized as an application specific integrated circuit (ASIC) that includes one or more electronic circuits arranged to perform the action, or a field programmable gate array (FPGA) that includes programmable electronic logic circuits that are arranged in series or parallel to perform the action in accordance with one or more instructions (e.g., via a configuration file for the FPGA). In some embodiments, the physical state of configuration of the hardware element may be specified through storing (e.g., in a memory device) program code (e.g., instructions in the form of firmware, software, etc.) that, when executed by a hardware processor, causes the hardware elements (e.g., by configuration of registers, memory, etc.) to perform the actions in accordance with the program code.

A hardware element (or elements) can therefore be understood to be configured to perform an action even when the specified hardware element(s) is/are not currently performing the action or is not operational (e.g., is not on, powered, being used, or the like). Consistent with the preceding, the phrase “configured to” in claims should not be construed/interpreted, in any claim type (method claims, apparatus claims, or claims of other types), as being a means plus function; this includes claim elements (such as hardware elements) that are nested in method claims.

Although process steps, algorithms, or the like, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

What is claimed is:

1. A system for allowing cross-domain security access to data stored by a blockchain network, comprising:
an ingest gateway configured to receive data records from one or more data sources, each data record comprising an associated security level attribute indicating an associated security level of each data record, the ingest gateway further configured to generate transformable object models (TOMs), each of the TOMs comprising two or more data records having a common attribute irrespective of a security level of each data record, wherein each TOM is assigned a TOM security level attribute matching a highest security level attribute of the two or more data records used to create each TOM;
wherein the blockchain network is coupled to the ingest gateway, the blockchain network comprising a plurality of processing nodes, the blockchain network providing a plurality of logical data channels, each of the logical data channels associated with a different security level, respectively, the plurality of processing nodes configured to each execute chaincode for creating cryptographic blocks, each cryptographic block comprising a respective TOM, and to publish each cryptographic block on a respective logical data channel having a security level equal to the TOM security level of each TOM of each cryptographic block, respectively; and
a gateway, coupled to the blockchain network, for authenticating requests to access the data records stored in the cryptographic blocks of a first logical data channel assigned to the gateway.

2. The system of claim 1, wherein the processing nodes each verify that a requesting entity is authorized to access the data records by comparing a security level of a requesting entity to the TOM security level of each TOM stored on the first logical data channel.

3. The system of claim 1, further comprising:
a plurality of additional gateways, each of the additional gateways for providing direct access to a particular logical data channel, respectively.

4. The system of claim 1, wherein the processing nodes, via the chaincode, is further configured to:
receive a request from a requesting entity, via the gateway, to access a first data record, the request comprising an identification of the first data record and a first security level of the requesting entity;
retrieve an authorization record from an authorization channel of the blockchain network associated with the first logical data channel, the authorization record identifying the first data record and associated attributes indicating conditions under which the first data record may be accessed;
determine that the requesting entity is authorized to access the first data record by comparing at least the security level of the requesting entity to a minimum security level listed in the authorization record;
identify a first cryptographic block previously published on the first logical data channel containing a first TOM comprising the first data record;
determine that the security level of the requesting entity is greater than or equal to the TOM security level of the first TOM; and
provide the first TOM to the requesting entity, via the gateway, when the security level of the requesting entity is greater than or equal to the TOM security level of the first TOM.

5. The system of claim 1, wherein the processing nodes, via the chaincode, is further configured to:
receive a request from a requesting entity, via the gateway, to access a first data record, the request comprising an identification of the first data record and a first security level of the requesting entity;
verify that the requesting entity is authorized to access the first data record;
identify a first cryptographic block previously published on the first logical data channel containing a first TOM comprising the first data record;
determine that the security level of the requesting entity is less than the TOM security level of the first TOM;
execute the chaincode to redact any data records from the first TOM having a security level attribute higher than the first security level of the requesting entity, to create a redacted TOM; and
publish the redacted TOM on a second data logic channel having a security level equal to or less than the first security level of the requesting entity.

6. The system of claim 1, wherein the processing nodes, via the chaincode, is further configured to:
receive a request from a requesting entity, via the gateway, to access a first data record, the request comprising an identification of the first data record and a first security level of the requesting entity;
verify that the requesting entity is authorized to access the first data record;
identify a first cryptographic block previously published on the first logical data channel containing a first TOM comprising the first data record;
determine that the security level of the requesting entity is less than the TOM security level of the first TOM;
execute the chaincode to redact any data records from the first TOM having a security level attribute higher than the first security level of the requesting entity, to create a redacted TOM; and
provide the redacted TOM to the requesting entity via the gateway.

7. The system of claim 1,
wherein the processing nodes, via the chaincode, is further configured to:
redact a first TOM published on the first logical data channel associated with the gateway to create a redacted TOM, the redacted TOM comprising a first data record of the first TOM, the first data record having a lower security level than a security level of the first logical data channel but excluding other data records having a security level equal to a security level of the first logical data channel; and
publish a first cryptographic block comprising the redacted TOM onto a second logical data channel of the blockchain network, the second logical data channel having a security level lower than the security level of the first logical data channel.

8. The system of claim 1, wherein the processing nodes, via the chaincode, are further configured to:
receive a task, via the gateway, the task comprising a subtask for performance by a first user having a first security level for access to a second logical data channel associated with the first security level, the task further comprising redaction rules for creating a redacted TOM for use by the first user to perform the subtask, the redacted TOM based on a first TOM stored in a cryptographic block on the first logical data channel associated with the gateway having a second security level higher than the first security level, the first TOM comprising a first data record associated with the first security level and a second data record associated with the second security level, the redacted TOM comprising the second data record but not the first data record;
execute the chaincode using the redaction rules and the first TOM to generate the redacted TOM; and
provide the redacted TOM to the first user via a second gateway associated with the second logical data channel.

9. The system of claim 1, wherein the processing nodes, via the chaincode, are further configured to:
receive a request, via the gateway, from a requesting entity to access a plurality of data records, the request comprising a first security level of the requesting entity;
determine that the request comprises data records stored on different logical data channels of the blockchain network in a plurality of TOMs;
identify a first cryptographic block published on the first logical data channel comprising a first TOM comprising a first data record identified in the request and a second cryptographic block published on a second logical data channel comprising a second TOM comprising a second data record identified in the request;
generate an aggregated TOM comprising the first data record and the second data record;
assigning a second TOM security level to the aggregated TOM equal to the highest security level of the first and second data records; and
publish a third cryptographic block comprising the aggregated TOM on a logical data channel having the second security level.

10. The system of claim 9, wherein the processing nodes, via the chaincode, are further configured to:
retrieve an identification code associated with each of the first and the second TOM; and
add the identification code of each of the TOMs as an ID attribute of the aggregated TOM to provide a lineage identifying the first and second TOMs used to generate the aggregated TOM.

11. The system of claim 1, wherein the blockchain network further comprises an authorization channel for storing cryptographic blocks each comprising an authorization record associated with at least some of the plurality of data records, each authorization record comprising a minimum security attribute for accessing an associated data record;
wherein the processing nodes, via the chaincode, are further configured to:
receive a request from a requesting entity to access a first data record, the request comprising a first security level of the requesting entity;
identify a first cryptographic block on the authorization channel comprising an authorization record associated with the first data record;
determine when the security level of the requesting entity meets or exceeds the minimum security attribute stored in the authorization record; and
provide access to the first data record, to the requesting entity, when the security level of the requesting entity meets or exceeds the minimum security attribute stored in the authorization record.

12. The system of claim 1, wherein a first data record of the plurality of data records comprises an authorization attribute listing an identity of one or more entities permitted to access the first data record, wherein the processing nodes, via the chaincode, are further configured to:
receive a request from a requesting entity to access the first data record, the request comprising an identity and a security level of the requesting entity;
identify a first cryptographic block containing a first TOM comprising the first data record, the first cryptographic block stored on the first logical data channel having a security level equal to, or less than, the security level of the requesting entity;
determine when the identity of the requesting entity matches an authorized entity identification in the authorization attribute of the first data record; and
provide access to the first data record, to the requesting entity, when the identity of the requesting entity matches an authorized entity identification in the authorization attribute of the first data record.

13. A method for allowing cross-domain security access to data stored by a blockchain network, the blockchain network providing a plurality of logical data channels, each of the logical data channels associated with a different security level, respectively, the method comprising:
receiving data records over a wide-area network from one or more data sources, each data record comprising an associated security level attribute indicating an associated security level of each data record;
generating transformable object models (TOMs), each of the TOMs comprising two or more data records having a common attribute irrespective of a security level of each data record, wherein each TOM is assigned a TOM security level attribute matching a highest security level attribute of the two or more data records used to create each TOM;
sending the TOMs to the blockchain network;
creating cryptographic blocks from the TOMs, each cryptographic block comprising a respective TOM;
publishing each cryptographic block on a respective logical data channel having a security level equal to the TOM security level of each TOM of each cryptographic block, respectively; and
authorizing requests to access the data records stored in the cryptographic blocks stored on a first logical data channel.

14. The method of claim 13, wherein authorizing requests to access the data records comprises comparing a security level of requesting entities each associated with the requests, respectively, to the TOM security level of each TOM stored on the first logical data channel.

15. The method of claim 13, further comprising:
assigning each of a plurality of gateways to a respective logical data channel, wherein each of the plurality of gateways is configured to provide direct access to a particular logical data channel, respectively.

16. The method of claim 13, further comprising:
receiving a request, by the blockchain network from a requesting entity, via a gateway assigned to the first logical data channel, to access a first data record, the request comprising an identification of the first data record and a first security level of the requesting entity;
wherein authorizing requests to access the data records comprises:
retrieving an authorization record from an authorization channel associated with the first logical data channel of the blockchain network, the authorization record identifying the first data record and associated attributes indicating conditions under which the first data record may be accessed;
determining that the requesting entity is authorized to access the first data record by comparing at least the security level of the requesting entity to a minimum security level listed in the authorization record;
identifying a first cryptographic block previously published on the first logical data channel containing a first TOM comprising the first data record;
determining that the security level of the requesting entity is greater than or equal to the TOM security level of the first TOM; and
providing the first TOM to the requesting entity, via the gateway, when the security level of the requesting entity is greater than or equal to the TOM security level of the first TOM.

17. The method of claim 13, further comprising:
receiving a request from a requesting entity, via a gateway assigned to the first logical data channel, to access a first data record, the request comprising an identification of the first data record and a first security level of the requesting entity;
identifying a first cryptographic block previously published on the first logical data channel containing a first TOM comprising the first data record;
determining that the security level of the requesting entity is less than the TOM security level of the first TOM;
creating a redacted TOM comprising any data records stored in the first TOM having a security level equal to or lower than the first security level of the requesting entity; and
publishing the redacted TOM on a second data logic channel having a security level equal to or less than the first security level of the requesting entity.

18. The method of claim 13, further comprising:
receiving a request from a requesting entity, via a gateway assigned to the first logical data channel, to access a first data record, the request comprising an identification of the first data record and a first security level of the requesting entity;
identifying a first cryptographic block previously published on the first logical data channel containing a first TOM comprising the first data record;
determining that the security level of the requesting entity is less than the TOM security level of the first TOM;
creating a redacted TOM comprising any data records stored in the first TOM having a security level equal to or lower than the first security level of the requesting entity; and
providing the redacted TOM to the requesting entity via the gateway.

19. The method of claim 13, further comprising:
redacting a first TOM published on the first logical data channel to create a redacted TOM, the redacted TOM comprising a first data record of the first TOM, the first data record having a lower security level than a security level of the first logical data channel but excluding other data records of the first TOM having a security level equal to a security level of the first logical data channel; and
publishing a first cryptographic block comprising the redacted TOM onto a second logical data channel of the blockchain network, the second logical data channel having a security level lower than the security level of the first logical data channel.

20. The method of claim 13, further comprising:
receiving a task, by the blockchain network via a gateway assigned to the first logical data channel, the task comprising a subtask for performance by a first user having a first security level for access to a second logical data channel associated with the first security level, the task further comprising redaction rules for creating a redacted TOM for use by the first user to perform the subtask, the redacted TOM based on a first TOM stored in a cryptographic block on the first logical data channel associated with the gateway having a second security level higher than the first security level, the first TOM comprising a first data record associated with the first security level and a second data record associated with the second security level, the redacted TOM comprising the second data record but not the first data record;
generating the redacted TOM using the redaction rules and the first TOM; and
providing the redacted TOM to the first user via a second gateway associated with the second logical data channel.

21. The method of claim 13, further comprising:
receiving a request, via a gateway assigned to the first logical data channel, from a requesting entity to access a plurality of data records, the request comprising a first security level of the requesting entity;
determining that the request comprises data records stored on different logical data channels of the blockchain network in a plurality of TOMs;
identifying a first cryptographic block published on the first logical data channel comprising a first TOM comprising a first data record identified in the request and a second cryptographic block published on a second logical data channel comprising a second TOM comprising a second data record identified in the request;
generating an aggregated TOM comprising the first data record and the second data record;
assigning a second TOM security level to the aggregated TOM equal to the highest security level of the first and second data records; and
publishing a third cryptographic block comprising the aggregated TOM on a logical data channel having the second security level.

22. The method of claim 21, further comprising:
retrieving an identification code associated with each of the first and the second TOM; and
adding the identification code of each of the TOMs as an ID attribute of the aggregated TOM to provide a lineage identifying the first and second TOMs used to generate the aggregated TOM.

23. The method of claim 13, wherein the blockchain network further comprises an authorization channel for storing cryptographic blocks each comprising an authorization record associated with at least some of the plurality of data records, each authorization record comprising a minimum security attribute for accessing an associated data record;
receiving a request from a requesting entity to access a first data record, the request comprising a first security level of the requesting entity;
identifying a first cryptographic block on the authorization channel comprising an authorization record associated with the first data record;
determining when the security level of the requesting entity meets or exceeds the minimum security attribute stored in the authorization record; and
providing access to the first data record, to the requesting entity, when the security level of the requesting entity meets or exceeds the minimum security attribute stored in the authorization record.

24. The method of claim 13, wherein a first data record of the plurality of data records comprises an authorization attribute listing an identity of one or more entities permitted to access the first data record, the method further comprising:
receiving a request from a requesting entity to access the first data record, the request comprising an identity and a security level of the requesting entity;
identifying a first cryptographic block containing a first TOM comprising the first data record, the first cryptographic block stored on the first logical data channel having a security level equal to, or less than, the security level of the requesting entity;
determining when the identity of the requesting entity matches an authorized entity identification in the authorization attribute of the first data record; and
providing access to the first data record, to the requesting entity, when the identity of the requesting entity matches an authorized entity identification in the authorization attribute of the first data record.
